(19) United States
(12) Patent Application Publication
(10) Pub. No.: US 2009/0318047 A1
(43) Pub. Date: Dec. 24, 2009

(54) Monofilaments Modified with Perfluoropolyethers

(75) Inventors: Hans-Joachim Bruning, Augsburg (DE); Ralf Michael Haber, Wehringen (DE); Holger Meid, Bubesheim (DE)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: TEIJIN MONOFILAMENT GERMANY GMBH, Bobingen (DE)

(21) Appl. No.: 12/485,524

(22) Filed: Jun. 16, 2009

(30) Foreign Application Priority Data
Jun. 18, 2008 (DE) 10 2008 028 617.6

(51) Int. Cl. D03D 15/00; B29C 47/00; B29C 47/12; D03D 49/20

(52) U.S. Cl. 442/181; 264/176.1; 264/177.13; 428/221; 525/355; 139/291 R

(57) ABSTRACT

A method is described which comprises a method for the production of a monofilament from a mixture of a melt-spinnable, filament-forming polymer and a modifying additional polymer, characterised in that a mixture of one or more melt-spinnable, filament-forming polymers and 0.001 to 10% by weight of a perfluorinated polyether is spun to form monofilaments.

The monofilaments are particularly well suited for woven fabrics which are used in paper machine clothings, conveyor belts, filtration screens and screens for silkscreen printing.

### BACKGROUND OF THE INVENTION

1. Field of the Invention

The invention relates to a method for producing monofilaments from fibre-forming polymers which are modified with perfluoropolyethers, a method for their production and their use for the production of textile fabrics, especially woven fabrics, and their use in paper machine coverings, conveyor belts, filtration screens and suchlike.

2. Summary of the Related Art

It is known to modify monofilaments made from synthetic polymers, especially those made from polyesters.

The modification is carried out because the properties of polyesters, which in themselves are very good, still leave something to be desired, and there is particular interest in improving the hydrolysis resistance, but also the dirt-repelling properties and the abrasive properties. Such monofilaments should also possess a sliding friction coefficient that is as low as possible.

Many attempts have already been made, especially in the case of polyester monofilaments, to obtain the corresponding desired properties and to reduce the disadvantageous properties. Thus, it is known to produce monofilaments from polyesters which have been modified by the addition of polytetrafluoroethylene.

Similar monofilaments made from polyesters are described in EP 0 506 983 A1, which have been modified by the addition of carbodiimides and fluorinated polymers of the tetrafluoropolyethylene type as well as corresponding copolymers.

This reference, however, does not disclose or render obvious the addition of perfluoropolyethers.

EP 0 617 743 B1 describes monofilaments made from polyester for paper machine screens, which have been modified by the addition of a special copolymer. The copolymer, which is added in quantities of 1.5 to 5% by weight, is a polynary copolymer which has been obtained from alkenes and perfluoroalkenes, in particular from ethylene and tetrafluoroethylene. The addition of perfluoropolyethers as disclosed by the invention, however, is neither disclosed nor rendered obvious by this reference.

DE 694 24 510 T2 discloses a polyester resin that has been modified by introducing perfluoropolyether blocks into the polymer chain. This reference does not mention the addition of perfluoropolyethers as disclosed by the invention nor does it render such addition obvious.

Furthermore, this publication relates to fibres and films and, in particular, the preparation of shaped bodies, such as blown objects and bottles for nutrition articles or beverages. Monofilaments are not mentioned or contemplated, and there is no suggest to use polyesters modified by these perfluoropolyether blocks for the preparation of monofilaments.

Finally, U.S. Pat. No. 3,847,978 describes perfluorinated linear polyethers that exhibit reactive end groups at each end of the polymer chain. These end groups are —COOHgroups. The use of perfluoropolyethers as disclosed by the present invention cannot be derived from this U.S. patent, which neither suggests nor renders obvious the use of such perfluoropolyethers as presently disclosed.

In all the monofilaments and methods for the production thereof described above, a drawback can in particular be observed, i.e. that the thorough mixing of these polymers proves to be difficult and is inadequate. The fluoropolymers in fact form more or less well distributed islands and heterogeneously distributed particles, so that in unfavourable cases thickened zones even occur in the monofilaments. During cleaning and the removal of residual soiling, especially with high-pressure cleaners, drawbacks then arise with the monofilaments such as fraying of the monofilament surfaces, i.e. so-called fibrillation, as a result of which the woven fabric more or less quickly becomes unusable.

In addition, the effect of fibrillation or even the first signs of fibrillation is that dirt residues remain adhering more firmly to the monofilaments and cleaning has to be carried out for longer, which is cost- and labour-intensive, and on the other hand the fibrillation increases and finally leads to the woven fabric having to be replaced at shorter intervals.

On account of the roughness, the abrasion with such monofilaments is also relatively high.

### SUMMARY OF THE INVENTION

There is therefore still a need for improved monofilaments as well as methods for the production of such monofilaments, especially which can be used in the form of woven fabrics and screens, for example in paper machine coverings, conveyor belts and filtration screens.

The object underlying the invention, therefore, is to make available monofilaments which do not exhibit the aforementioned drawbacks or which are improved compared to the known monofilaments, which in particular do not have or have only a reduced tendency towards fibrillation, which possess a reduced roughness and therefore a lesser tendency towards abrasion, have a reduced tendency to soiling, which possess a homogeneous internal structure and which therefore, especially when used in the form of woven fabrics in paper machines, have to be cleaned less often and can also be cleaned more easily.

A further aim of the monofilaments according to the invention is a reduced sliding friction resistance. Associated therewith is a reduced energy consumption in the drive power of the paper machine.

### BRIEF DESCRIPTION OF THE DRAWING

The drawing displays exemplary possible cross-sections of monofilaments according to the invention.

### DETAILED DESCRIPTION OF THE INVENTION

This object is achieved by a method for the production of a monofilament from a mixture of a melt-spinnable, filament-forming polymer and a modifying additional polymer, which is characterised in that a mixture of one or more melt-spinnable, filament-forming polymers and 0.001 to 10% by weight of a perfluorinated polyether is spun to form monofilaments.

These perfluoropolyethers are inert liquids that have a molecular weight of 500-6,000 Da and that do not have —COOH or —OH end groups that could react with polyester, polyamide or polycarbonate polymers. The perfluoropolyethers can be represented by the chemical formula:

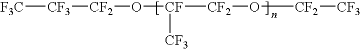

wherein n is a number resulting in a molecular mass of the perfluoropolyether in the range of 500-6,000 Da.

Suitable perfluorpolyethers are commercially available. Perfluoropolyethers that are particularly suitable for use in the present invention are oil-like inert liquids that are pumpable.

Very suitable for use in the present invention are perfluoropolyethers marketed by Du Pont under the trademark FLUOROGUARD®. They are available from Du Pont de Nemours (Belgium) BVBA, DuPont Chemical Solution Enterprise, Ketenislaan 1, Haven 1548, B-9130 Kallo, Belgium.

Polyesters, polyamides or polycarbonates are preferred as melt-spinnable, filament-forming polymers.

As polyesters, use is preferably made of polyethylene terephthalate, polypropylene terephthalate, polybutylene terephthalate, polyethylene naphthalate and polybutylene naphthalate.

As polyamides, use is preferably made of PA 6, PA 4.6, PA 6.6, PA 6. 10, PA 6.12, PA 11 or PA 12.

Mixtures of the aforementioned polymers can also be used.

It is advantageous if the mixtures also contain stabilisers such as hydrolysis stabilisers, thermostabilisers and/or UV stabilisers.

Dyestuffs, in particular pigment dyestuffs, can also be used in the mixtures.

The diameter of the monofilaments can amount to 10 μm to 2.00 mm, preferably 0.1 mm to 1.00 mm.

It is possible to produce the monofilaments with a round or a non-round cross-section, in particular an oval cross-section, but also with an n-sided cross-section with n≧3.

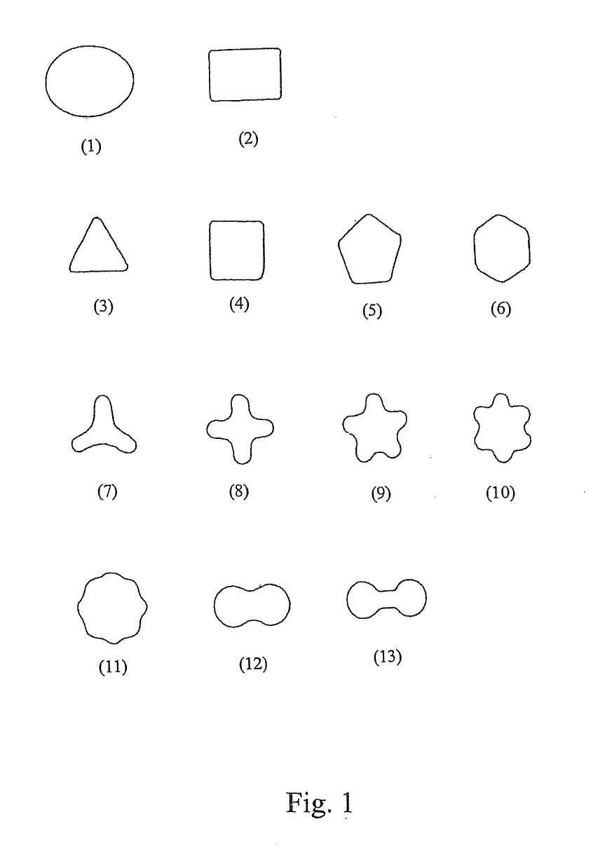

Corresponding cross sections are given in FIG. 1.

A further subject-matter of the invention is monofilaments which are constituted by a mixture of one or more melt-spinnable, filament-forming polymers, which contains 0.001 to 10% by weight, preferably 0.01 to 1% by weight, of a perfluorinated polyether.

They are preferably obtained according to one of the aforementioned methods. A subject-matter of the invention is also therefore monofilaments obtained according to one of the methods described above.

These monofilaments are characterised, amongst other things, by the following properties: low abrasion and low fibrillation tendency.

As a coefficient of measure for abrasion, the knife edge test for example can be used.

A monofilament under constant initial tension is pulled over a knife edge. The number of to-and-fro cycles is counted up to breakage of the filament.

A coefficient of measure for the fibrillation tendency can be the cam strike test: the number of splayed-out portions after 1000 hammer blows at different points of the monofilament is counted; the fibrillation tendency is usually assessed visually according to the high-pressure shower test.

A subject-matter, therefore, is monofilaments which are constituted by a mixture comprising one or more melt-spinnable, filament-forming polymers which contains 0.001 to 10% by weight, preferably 0.01 to 1% by weight, of a perfluorinated polyether.

The soiling tendency (possibly on account of the hydrophobic surface), the sliding resistance and thus the abrasion are reduced by means of the perfluorinated polyether. As a result of the reduced sliding friction, the drive power of the paper machine and thus its energy consumption are also reduced.

A further subject-matter of the invention is the use of the monofilaments outlined above for the production of textile fabrics, in particular textile and technical woven fabrics.

A further object of the invention is the use of the textile or technical woven fabrics for the production of paper machine coverings, conveyor belts, filtration screens and screens for silkscreen printing.

Melt-spinnable, filament-forming polymers have long been known and their production is familiar to the average person skilled in the art.

All the usual filament-forming polymers can in principle be used. Polyesters such as polyethylene terephthalate should in particular be highlighted.

Perfluorinated polyethers are also polymers known per se. In this connection, reference is made to RÖMPP Lexikon Chemie 10., completely revised version on page 3181; reference is made to the disclosure indicated there and is included herewith.

Perfluoropolyethers are preferably added in the form of master batches. Suitable master batches are marketed by the firm RTP Company, 580 East Front Street, Winona, Minn. 55987, USA, e.g. under the type designation 1099X99974.

The production of monofilaments per se has also long been known, and the average person skilled in the art can carry out the spinning of polymers to form monofilaments without inventive step.

A melt is generally produced from the components to be spun, said melt being spun through a nozzle which endows the emerging monofilament with a suitable cross-section. The mixture to be spun is generally melted in an extruder and is then pressed through the nozzle with the aid of a melt pump. Coming from the nozzle, the formed product is generally conveyed with a draft ratio of 1:1.1 to 1:5 through a cooling medium, preferably water with a temperature of 10° C. to 90° C., the obtained filament is then stretched once or repeatedly and thermofixed until it has the desired dimensions, i.e. the desired titre.

The delivery quantity, if appropriate the draft and the stretching are adapted to one another in such a way that the obtained monofilament reaches a diameter of approx. 100 μm to 5 mm, in particular 0.1 to 2 mm. As nozzles, use may be made of nozzles with a simple round cross-section or oval cross-section. It is however also possible to produce filaments with a profiled cross-section, e.g. rectangular or n-sided, whereby n≧3.

Commonly used agents can be used as stabilisers, especially those for improving the hydrolysis resistance, thermal resistance and UV-light resistance. Monomeric and polymeric carbodiimides in particular are suitable for improving hydrolysis resistance.

Pigment dyestuffs in particular are used as dyestuffs.

The production of textile fabrics, especially also textile and technical woven fabrics, is also known per se to the average person skilled in the art.

The woven fabrics that are used as clothing in paper machines are eminently well suited both in the wet end and in the following parts, especially also in the dry end.

The monofilaments are characterised by a particular homogeneous structure.

The invention is explained in greater detail by the following example:

### EXAMPLE

In the main PET flow in the downpipe of the extruder, 4% of the master batch RTP 1099 X 99974 was added by metering gravimetrically, melted in the extruder, pushed by a gear pump into a spinpack, spun through a nozzle plate to form fine, round strands, quenched in a spinning bath, stretched repeatedly over galettes under the effect of heat and wound up as individual filaments with a diameter of 0.50 mm. The metered addition of 4% master batch into the diced flow before the extrusion corresponds to <1% by weight of PFPE in the finished monofilament. The procedure was carried out according to the following operational data:
Operational Data:

| Extruder | 45 mm diameter, 280° to 290° C. | |
|---|---|---|
| Spinning pump | 45 cm³, delivery 405 g/min | |
| Spinning nozzle | 16 holes, 1.6 mm diameter | |
| Spinning bath | 60° | C. |
| Drafting arrangement 1 | 27 | m/min |
| Drafting bath 1 | 85° | C. |
| Drafting arrangement 2 | 102 | m/min |
| Drafting bath 2 | 90° | C. |
| Drafting arrangement 3 | 143 | m/min |
| Fixing channel | 230° | C. |
| Drafting arrangement 4 | 120 | m/min |

As a reference, use was made of monofilament type 0.50 mm 910 CK white, which contains 15% of a conventional fluoropolymer in PET. The textile data are entered in the table:

TABLE

| Material type | | | 0.50/910CK | 0.50/910CK |
|---|---|---|---|---|
| Appearance | | | White | White |
| Test No | | | V7265 | V7264 |
| produced from-to | | | 24 Jul. 2007 | 24 Jul. 2007-25 Jul. 2007 |
| On-line number | | | 20 | 20 |
| Polymer | Base polymer | | RT12* | RT12* |
| | Additive | | 4.0% RTP 1099X99974** | 15.0% PVDF*** |
| | | | 0.7% stabiliser | 0.7% stabiliser |
| The diameter and titre | | dtex | | |
| Titre | | μm | 2818 | 2826 |
| Diameter | x | | 503 | 503 |
| Rupture strength | | CN/tex | 34.3 | 33.4 |
| Elongation at rupture | | N | 96.8 | 94.4 |
| relative elongation | at 15 cN/tex | % | 37.9 | 35.6 |
| | at 20 cN/tex | % | 10.5 | 10.5 |
| | at 27 cN/tex | % | 16.0 | 16.0 |
| | at 40 cN/tex | % | 22.5 | 22.3 |
| Modulus | N at 1% | % | — | — |
| elongation | | % | 17.9 | 17.4 |
| | | [N/mm²] | 9028.1 | 8776.5 |
| | | [kg/mm²] | 920.9 | 895.2 |
| Hot air shrinkage | | | | |
| Oven without air circulation | | % | 4.6 | 4.8 |
| 180° C. - 30 min. | | | | |
| Max. shrinkage force | | CN | 125.9 | 128.9 |
| At temperature | | CN/tex | 0.4 | 0.5 |
| Initial tension 0.1 cN/tex | | ° C. | 179 | 179 |
| | | g | 28 | 28 |
| Shrinkage at 180° C. | | % | 2.4 | 2.8 |
| Initial tension 0.1 cN/tex | | g | 28 | 28 |
| Knife edge test | | | | |
| Device 552 | untreated | min. | 14,017 | 2,446 |

| | | | |
|---|---|---|---|
| | max. | 17,103 | 7,158 |
| | median | 14,797 | 2,905 |
| Fixed with tentering frame | min, | 13,104 | 2,298 |
| 190° C. - 10 min. | max. | 21,761 | 2,995 |
| | median | 15,619 | 2,696 |
| Hydrolysed | min, | 756 | 491 |
| 32 h - 4.20 Bar (145° C.) | max. | 1,709 | 1,002 |
| N = 10 | median | 1,402 | 807 |

*= Polyester from the firm Invista Resins and Fibres GmbH
**= Master batch from the firm RTP Company, 580 East Front Street, Winona MN 55987, USA
***= PVDF = polyvinylidiene fluoride

In order to test the fibrillation tendency, the monofilaments were wound lying parallel on a metal plate and bombarded with a high-pressure water jet of 300 bar. As a result, the monofilaments according to the invention do not display any fibrillation, whereas the reference sample treated under identical conditions displayed marked fibrillations.

What is claimed is:

1 A method for the production of a monofilament from a mixture of a melt-spinnable, filament-forming polymer and a modifying additional polymer, the method comprising spinning a mixture of (a) one or more melt-spinnable, filament-forming polymers and (b) 0.001 to 10% by weight of a perfluorinated polyether to form monofilaments.

2. The method according to claim 1, wherein the perfluorinated polyether is an inert liquid perfluorinated polyether of molecular weight of 500-6,000 Da.

3. The method according to claim 1, wherein the melt-spinnable, filament-forming polymers are polyesters, polyamides or polycarbonates.

4. The method according to claim 3, wherein the polyesters are selected from polyethylene terephthalate, polypropylene terephthalate, polybutylene terephthalate, polyethylene naphthalate and polybutylene naphthalate.

5. The method according to claim 3, wherein the polyamide is PA 6, PA 4.6, PA 6.6, PA 6.10, PA 6.12, PA 11 or PA 12.

6. The method according to claim 1, wherein the mixture comprises more than one melt-spinnable, filament-forming polymer.

7. The method according to claim 1, wherein the mixture additionally comprises a stabilizer.

8. The method according to claim 1, wherein the mixture additionally comprises a dyestuff.

9. The method according to claim 1, wherein the diameter of the monofilament is 10 μm-2.00 mm.

10. The method according to claim 1, wherein the method further comprises spinning the monofilaments with a round, non-round, oval or n-sided cross-section with n≧3.

11. A monofilament produced from mixture of a melt-spinnable, filament-forming polymer and a modifying additional polymer, wherein the mixture comprises one or more melt-spinnable, filament-forming polymers and 0.001 to 10% by weight of a perfluorinated polyether.

12. A monofilament produced by the method according to claim 1.

13. A method of producing a textile fabric, the method comprising forming the textile fabric from a monofilament according to claim 11.

14. A method of producing textile and technical woven fabrics, the method comprising forming the textile or technical woven fabric from a monofilament according to claim 11.

15. A method of producing a paper machine clothing, conveyor belt, filtration screen or screen for silkscreen printing, the method comprising forming the paper machine clothing, conveyor belt, filtration screen or screen for silk printing with a textile or technical woven fabric produced by the method of claim 13.

16. The method according to claim 1, wherein the mixture further comprises a hydrolysis stabilizer, a thermostabilizer, and/or a UV stabilizer.

17. The method according to claim 1, wherein the mixture further comprises a pigment dyestuff.

18. The method according to claim 1, wherein the diameter of the monofilaments is 0.1-1.00 mm.

19. A textile fabric, wherein the textile fabric comprises a monofilament according to claim 12.

20. A textile or technical woven fabric, wherein the textile or technical woven frabic comprises a monofilament according to claim 12.

21. A paper machine clothing, conveyor belts, filtration screens or screens for silkscreen printing, wherein the paper machine clothing, conveyor belts, filtration screens or screens for silkscreen printing a textile or technical woven fabric according to claim 20.
